(19) United States
(12) Patent Application Publication
(10) Pub. No.: US 2024/0406257 A1
(43) Pub. Date: Dec. 5, 2024

(54) Systems and methods for uploading content items to a server computing system

(71) Applicant: Canva Pty Ltd, Surry Hills (AU)

(72) Inventors: Sergei Grigorev, Macquarie Park (AU); Neng Yang, Surry Hills (AU); Christopher James Cook, Oatlands (AU)

(73) Assignee: Canva Pty Ltd, Surry Hills (AU)

(21) Appl. No.: 18/678,209

(22) Filed: May 30, 2024

(30) Foreign Application Priority Data
Jun. 2, 2023 (AU) 2023203480

(51) Int. Cl. H04L 67/104

(52) U.S. Cl. CPC H04L 67/1048; H04L 67/1046; H04L 67/1059

(57) ABSTRACT

Method, system and computer readable medium for uploading content items to a server computing system. The method including: receiving, at a client application executing on a first device, a request to upload a content item to a server system; establishing a peer-to-peer connection between the client application on the first device and a second device; transferring from the second device to the client application on the first device, the content item, the content item transferred via the peer-to-peer connection; and uploading the content item from the client application to the server system using a different communication channel between the first device and the server system.

### CROSS-REFERENCE TO RELATED APPLICATION

This application is a U.S. Non-Provisional Application that claims priority to Australian Patent Application No. 2023203480, filed Jun. 2, 2023, which is hereby incorporated by reference in its entirety.

### TECHNICAL FIELD

Aspects of the present disclosure are directed to computer applications and more particularly to systems and methods for uploading content items from user devices to server computing systems.

### BACKGROUND

Often computer applications provide mechanisms for users to upload their own content items (e.g., images, videos, text files, design elements, etc.) to the computer application. Users can then use the uploaded content items on the computer application to perform tasks—e.g., create pages, designs, templates, etc.

However, existing mechanisms that allow users to upload their content items to computer applications have issues. For example, such mechanisms are often tedious and time consuming, requiring multiple manual steps, especially when the content items to upload are not present on the device on which the computer application is executing.

Thus, there exists a need for better mechanism to upload content items from a user device to a computer application.

### SUMMARY

According to a first aspect of the present disclosure there is provided a computer implemented method for uploading a content item to a remote server. The method includes: receiving, at a client application executing on a first device, a request to upload a content item to a server system; establishing a peer-to-peer connection between the client application on the first device and a second device; transferring from the second device to the client application on the first device, the content item, the content item transferred via the peer-to-peer connection; and uploading the content item from the client application to the server system using a different communication channel between the first device and the server system.

According to a second aspect of the present disclosure there is provided a computer-readable medium comprising instructions, which when executed by a processor cause the processor to receive, at a client application executing on a first device, a request to upload a content item to a server system; establish a peer-to-peer connection between the client application on the first device and a second device; transfer from the second device to the client application on the first device, the content item, the content item transferred via the peer-to-peer connection; and upload the content item from the client application to the server system using a different communication channel between the first device and the server system.

### BRIEF DESCRIPTION OF THE DRAWINGS

In the drawings:

FIG. 1 is a diagram depicting a networked environment in which various features of the present disclosure may be implemented.

FIG. 2 is a block diagram of a computer processing system configurable to perform various functions of the present disclosure.

FIG. 3 is a flowchart illustrating an example method for transferring one or more content items from a user device to a server computing system according to some embodiments of the present disclosure.

FIG. 4 is a flowchart illustrating an example method for establishing a peer-to-peer connection between a user device and a client application on an external device according to some embodiments of the present disclosure.

FIG. 5 is an example user interface displayed by a client application according to some embodiments of the present disclosure.

FIG. 6 is another example user interface displayed by the client application according to some embodiments of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As described previously, many computer applications allow users to upload their own content items to the computer application. For example, consider digital design applications such as Canva, that allow users to upload media items (e.g., images, videos, or design elements) to the Canva website so that users can use their own media items in designs, presentations, videos, etc. Similarly, other computer applications exist, such as educational computer applications, which allow users to upload their assignments or exams. Still other computer applications, e.g., computer applications hosted by government agencies, may exist that allow users to upload photos or other documents (e.g., license copies) to the computer application for processing.

In these computer applications, the conventional process for uploading the content item from a user device (on which the content item is present) to the computer application is complex and time consuming when the computer application is open and executing on a different electronic device (e.g., another user device, a third party device, or a standalone device, such as a kiosk, associated with the computer application).

For example, in order to upload a content item from a user device to a computer application executing on another device (referred to as a second device in this example), the user has to first transfer the content item from the user device to the second device. This may be done, e.g., by emailing the content item to an email address and then accessing the email account associated with that email address from the second device (in case the second device includes an email application) and downloading the content item to the local memory of the second device. Alternatively, it could be done by connecting the user device to the second device by some communication means, e.g., a physical wire or wireless means, and then accessing the content library of the user device from the second device, selecting the content item, and then transferring the content item from the user device to a local memory of the second device. Once the content item is available at the second device, the user has to access the computer application from the second device, select an option in the executing computer application to upload the content item, browse to the local location on the second device where the content item is stored, and then upload the content item to the computer application. In some cases, the user may also have to subsequently delete the content item from the second device's local memory if the user does not want other people accessing the content item from the second device.

Such a process is not only time consuming, but also increases the cognitive burden on the user.

To address one or more of such issues with uploading content items from a user device to a computer application executing on a second device distinct from the first device, aspects of the present disclosure provide novel systems, methods, and/or computer readable media (CRM) that are configured to allow performance of such operations in a more efficient manner (saving time) while reducing the cognitive burden on the user. Generally speaking, the systems include a user device, an external device, and a computer application. The computer application includes a client running on the external device and a remote server (single computer system or distributed computing nodes) connected to the client via conventional communication means (e.g., the Internet). In addition, the systems may include a connection server that is independent of the remote server in some embodiments but part of the remote server in other embodiments.

When understood from the perspective of the external device (or second device), the currently disclosed systems, methods and CRM are configured to receive a request from a user to upload one or more content items to the remote server of the computer application using the computer application client executing on the external device. In response to the request, the client executing on the external device initiates a peer-to-peer connection between the computer application client and the user device. Once the peer-to-peer connection is established, the user may be able to select content items on the user device and these may be directly uploaded from the user device to the computer application client executing on the external device. Thereafter, the computer application client may communicate the uploaded content items to the computer application's remote server. This way the content items need not be first transferred to the local memory of the external device and then uploaded from there to the client application executing on that device. Instead, they can be directly uploaded from the user device to the client application executing on the external device. This not only reduces memory requirements for the external device but also improves security, as the content items are not available for other users to access from the local memory of the external device. Further still, using the presently disclosed techniques, users do not need to login to the computer application on their mobile/user devices. This is not only secure but also convenient.

Establishing the peer-to-peer connection between the user device and the external device may involve an intermediary system (e.g., the connection server) and establishing a signalling connection or channel between the external device and the intermediary and between the user device and the intermediary. Once the signalling channel is established via the intermediary system, the external device may establish a peer-to-peer connection directly between the external device and the user device using the signalling channel. After the peer-to-peer connection is established, the signalling connection is disabled and all data transfer from the user device to the external device occurs via the peer-to-peer connection.

This way, the user does not have to perform any complex, time consuming operations to transfer the content items from the user device to the external device before they can be uploaded to the computer application client. Further, the disclosed methods can be performed by utilizing a local wireless network (e.g., WiFi) and does not require a mobile network or any other wired connection means to transfer the content items from the user device to the external device.

In one example, to establish the signalling connection between the user device and the intermediary system (once a session is established between the external device and the intermediary), the external device may generate and display a URL of the intermediary system (along with information about the session established between the external device and intermediary system). The user can access the URL using the user device and provide the information about the session established between the external device and the intermediary so that the intermediary can connect the user device to the same session. In some instances, the external device may generate and display the URL and session information in the form of a machine readable code (e.g., a QR code). The user may scan the machine readable code using a code scanner (e.g., a camera) of the user device or by typing the URL in a search bar of a web browser. This may cause the user device to automatically access the URL and automatically provide the session information to the intermediary system, thereby further reducing user effort and the cognitive burden placed on the user even more.

These and other aspects of the present disclosure will now be described with reference to the following figures.

### Network Architecture and System

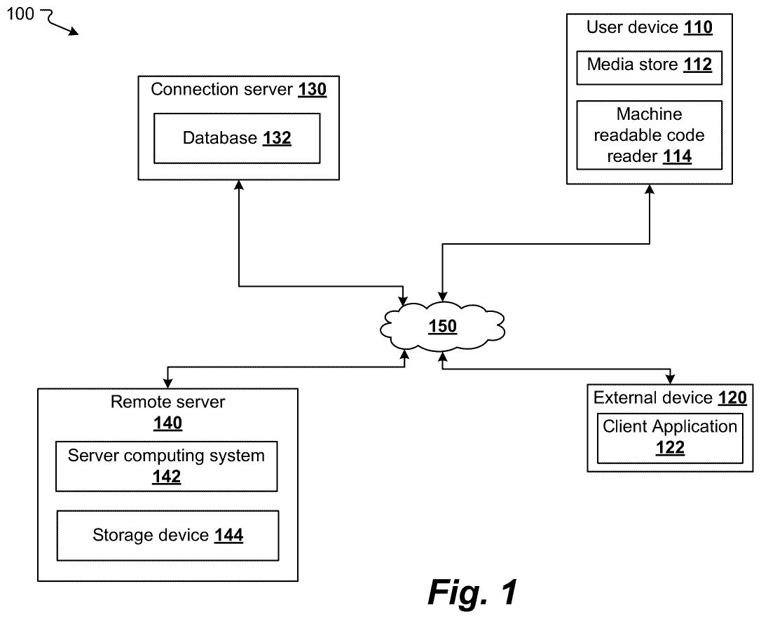

FIG. 1 is a diagram depicting a networked environment in which various features of the present disclosure may be implemented.

Embodiments of the present disclosure are described with reference to the networked environment which includes a user device 110, an external device 120, a connection server 130, and a remote server 140 which operate together to perform the operations described herein.

The devices 110, 120 and servers 130, 140 communicate with one another via one or more communication networks 150 (e.g., the Internet). For example, the user device 110 and external device 120 may communicate with each other via a mobile network or a local area network (e.g., WiFi). The external device 120 may communicate with the connection server 130 and the remote server 140 via a public internetwork in some embodiment.

The user device 110 may be any suitable device with network connectivity capable of communicating with the external device 120. Examples of user devices 110 include mobile devices (e.g. tablets, watches, or mobile phones), portable devices (such as laptop computers), or any other computing devices (e.g. desktop computers).

The user device 110 includes a media storage 112 that stores one or more content items (e.g., images, videos, documents, etc.). Further still, in some embodiments, the user device 110 includes a machine readable code reader 114—e.g., a QR code reader/scanner, that is configured to recognize machine readable codes, decrypt the machine readable codes, and perform one or more operations based on the decrypted machine readable code (e.g., access a URL, communicate information to a system associated with the URL, etc.). It will be appreciated that in some devices, a camera application (not shown) may be configured to perform the operation of the machine readable code reader 114 and in such cases, a separate machine readable code reader/scanner is not required.

The remote server 140 is a system entity that hosts one or more computer applications and/or content. The remote server 140 may include one or more server computing systems or nodes (e.g., 142) for hosting corresponding computer application(s) and one or more storage devices (e.g., storage device 144) for storing application specific data. Examples of computer applications hosted by the remote server 140 may include a digital design applications (e.g., Canva designs), collaborative applications, educational applications, etc.

To run a particular computer application, the server computing system 142 includes one or more application programs, libraries, APIs, or other software elements that implement the features and functions of the application. In one example, the server computing system 142 includes a design creation module (not shown) which provides functionality for creating and viewing digital designs.

The remote server 140 also stores application data. Application data generally includes: data defining the operation of the hosted application (for example, user accounts, user permissions, and the like); and application data (i.e., the content hosted/maintained by the application, which can be, for example, content items uploaded by users, content items created by developers of the computer application, etc. The data is stored on and managed by storage devices 144. The storage devices 144 are provided by a database server which may be hosted by remote server 140, but is more typically hosted on a separate physical computer in communication (directly or indirectly via one or more networks) with the remote server 140.

The server 140 may execute to provide a client application endpoint that is accessible over the communication network 150. In some examples, the server 140 is a web server, which serves web browser clients and receives and responds to HTTP requests. In another example, the server 140 may be an application server, which serves native client applications and is configured to receive, process, and respond to specifically defined API calls received from those client applications. The server 140 may include one or more web server applications and/or one or more application server applications allowing it to interact with both web and native client applications.

While single server architecture has been described herein, it will be appreciated that the server 140 can be implemented using alternative architectures. For example, in certain cases a clustered architecture may be used where multiple server computing instances (or nodes) are instantiated to meet system demand. Conversely, in the case of small enterprises with relatively simple requirements a server 140 may be a stand-alone implementation (i.e. a single computer directly accessed/used by the client).

External devices 120 may be any device suitable for performing client-side operations described herein, for example a mobile device (e.g. a tablet or mobile phone), a portable device (such as laptop computer), or any other computing device (e.g. a desktop computer, a kiosk with an in-built computing system, a special-purpose computer, etc.).

Generally speaking, users can use the external device 120 to generate and/or communicate electronic content to the remote server 140. This activity includes any type of interaction associated with the computer application hosted by the remote server. For example, if the remote server hosts a digital design application, the external device 120 may be utilized to access/view, create, or modify designs hosted by the digital design application. If the remote server hosts a knowledge management application, the external device may be utilized to access, view, create, or modify one or more documents hosted by the server 140, write posts, comment on content, visit web pages, etc. In addition, the external device 120 may be utilized to upload one or more content items to the remote server 140.

To allow users to perform these functions, as illustrated in FIG. 1, the external device 120 includes one or more client (software) applications (e.g., client application 122) that is configured to access software applications made available by the server 140 and establish connection with the connection server 130 and the user device 110.

The client application 122 includes instructions and data stored in the memory (e.g. non-transitory computer readable media) of the external device 120 on which the application is installed/run. These instructions are executed by a processor of the external device 120 to perform various functions as described herein. By way of example, some functions performed by the client application 122 include communicating with applications hosted by the server 140, receiving requests to upload content items from users, receiving one or more content items from the user device 110, uploading one or more content items to the server 140. Additional functions of the client application 122 include establishing connection with the connection server, generating, and displaying information to aid the user device 110 in connecting with the connection server 130, and establishing a connection with the user device 110.

The client application 122 may be implemented in various ways. For example, if the server 140 is a web server, the client application 122 may be web browser application (such as, for example, Chrome, Safari, Internet Explorer, Opera) which accesses the one or more computer applications hosted by the server 140 and/or communicates with the connection server 130 via appropriate uniform resource locators (URL) and communicates with these servers 130, 140 via general world-wide-web protocols (e.g. HTTP, HTTPS, FTP). In this case, the web browser application 122 is configured to request, render, and display user interfaces that conform to a mark-up language such as HTML, XML or extensions, and may be capable of internally executing browser-executable code such as JAVASCRIPT, or other forms of code. Alternatively, if the server 140 is an application server, the client application 122 may be a specific application programmed to communicate with the server 140 and/or connection server 130 using defined application programming interface (API) calls.

The connection server 130 is generally configured to aid in establishing a peer-to-peer connection between the external device 120 and the user device 110. In particular, it is configured to establish a signalling connection between the external device 120 and the user device 110. To do so, the connection server 130 receives a session request from the external device 120, establish a session with the external device 120 based on the request, and communicate a connection confirmation message (including information about the session) to the external device 120. The connection server 130 is also configured to receive a second session request from the user device 110 (that includes information about the already established session between the connection server 130 and the external device 120), join the user device 110 to the session with the external device 120, and communicate a session connection confirmation message to the user device 110 and/or external device 120.

In addition, once a signalling connection is established between the connection server 130 and the external device 120 and user device 110, the connection server 130 is configured to relay any signalling messages received from the external device 120 to the user device 110 to aid in establishing a peer-to-peer connection between the user device 110 and the external device 120. Once the peer-to-peer connection is established, the signalling connection can be disconnected.

In some examples, the signalling channel or connection is a Websocket channel. A Websocket channel is a persistent, bi-directional communication channel between two computing devices over a non-persistent connection such as the Internet. It allows for real-time data transfer between a two devices without the need for any one of the devices to continuously poll the other device for updates.

Websocket provides a full-duplex communication channel over a single TCP connection. They are designed to work over the same ports as HTTP and HTTPS and generally use a standard handshake to establish the connection. Once the connection is established, data can be sent back and forth between the two devices in real-time.

In other examples, the signalling connection may be a long-polling connection. A long polling connection is also a persistent connection between two devices for real-time data transfer. However, long polling is a unidirectional, half-duplex communication channel that uses multiple HTTP requests, In long polling, the devices send requests to the connection server 130, and the connection server 130 holds the channel open until new data is available or a timeout occurs. When new data is received from a transmitting device, the connection server 130 either communicates the data to a receiving device and/or sends a response to the transmitting device, and in response, the transmitting device can send another request to the connection server 130, essentially repeating the process.

Generally speaking, long polling allows for real-time updates without the need for continuous polling from the client. This technique has a higher latency than websocket but has a lower throughput.

The connection server 130 includes a database 132 for storing session IDs for any active connections with external devices 120 and/or user devices 110. If the connection server 130 uses long-polling, it may also include a database to store unsent messages (i.e., messages received from the external device or user device but not communicated to the user device or external device, respectively).

### Computer System

As noted, the techniques and operations described herein are performed by one or more computer processing systems.

By way of example, external device 120 may be any computer processing system which is configured (or configurable) by hardware and/or software—e.g. client application 122—to offer client-side functionality. An external device 120 may be a desktop computer, laptop computer, tablet computing device, mobile/smart phone, a kiosk, or other appropriate computer processing system.

Similarly, the applications of servers 130 and 140 are also executed by one or more computer processing systems. Server environment computer processing systems will typically be server systems, though again may be any appropriate computer processing systems.

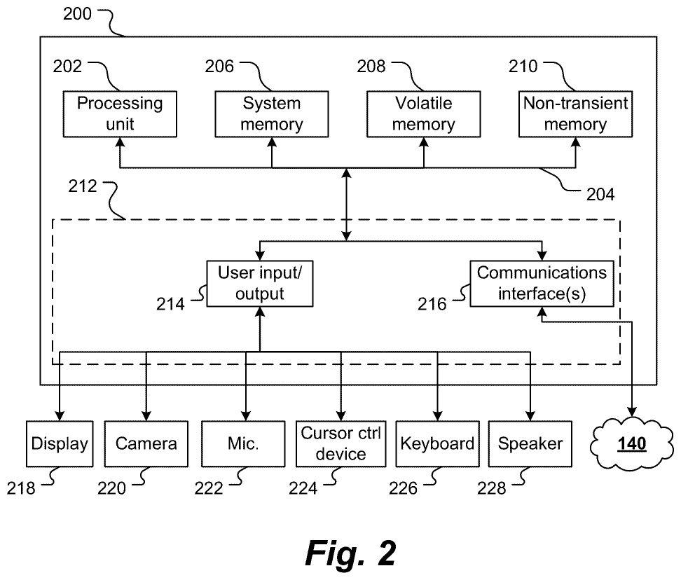

FIG. 2 provides a block diagram of a computer processing system 200 configurable to implement embodiments and/or features described herein. System 200 is a general-purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine-readable storage (memory) devices, which store computer readable instructions and/or data, which are executed by the processing unit 202 to control operation of the processing system 200. In this example system 200 includes a system memory 206 (e.g. a BIOS), volatile memory 208 (e.g. random access memory such as one or more DRAM modules), and non-transitory computer-readable media 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, connection between the device and system 200 may be via wired or wireless hardware and communication protocols, and may be a direct or an indirect (e.g. networked) connection.

Generally speaking, and depending on the particular system in question, devices to which system 200 connects-whether by wired or wireless means-include one or more input devices to allow data to be input into/received by system 200 and one or more output device to allow data to be output by system 200. Example devices are described below, however it will be appreciated that not all computer-processing systems will include all mentioned devices, and that additional and alternative devices to those mentioned may well be used.

For example, system 200 may include or connect to one or more input devices by which information/data is input into (received by) system 200. Such input devices may include keyboard, mouse, trackpad, microphone, accelerometer, proximity sensor, GPS, and/or other input devices. System 200 may also include or connect to one or more output devices controlled by system 200 to output information. Such output devices may include devices such as a display (e.g. a LCD, LED, touch screen, or other display device), speaker, vibration module, LEDs/other lights, and/or other output devices. System 200 may also include or connect to devices which may act as both input and output devices, for example memory devices (hard drives, solid state drives, disk drives, and/or other memory devices) which system 200 can read data from and/or write data to, and touch screen displays which can both display (output) data and receive touch signals (input).

By way of example, where system 200 is a user device 110 or external device 120 it may include a display 218 (which may be a touch screen display), a camera device 220, a microphone device 222 (which may be integrated with the camera device), a cursor control device 224 (e.g. a mouse, trackpad, or other cursor control device), a keyboard 226, and a speaker device 228.

System 200 also includes one or more communications interfaces 216 for communication with a network, such as network 150 (and/or a local network within the server 140). Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, kiosk, or an alternative computer processing system.

System 200 stores or has access to computer applications (also referred to as software or programs)—i.e. computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, remote server 140 includes one or more server systems, which run a computer application, and a data storage application (not shown). Similarly, external device 120 runs a client application 122.

In some cases, part or all of a given computer-implemented method will be performed by system 200 itself, while in other cases processing may be performed by other devices in data communication with system 200.

### Methods

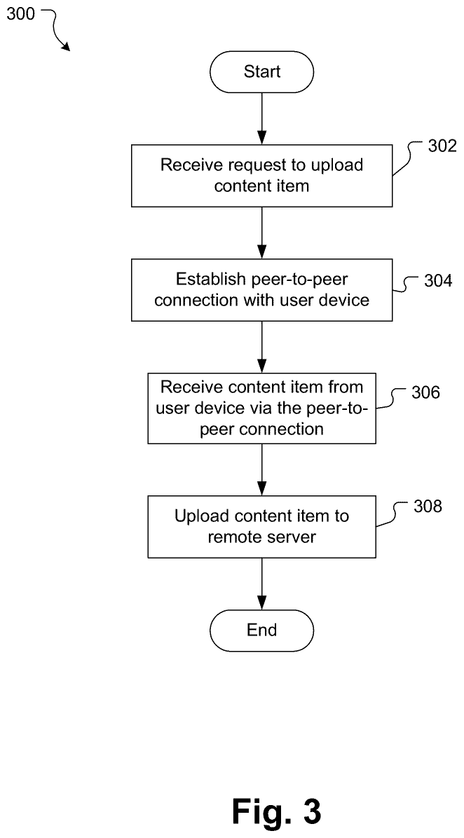

Various methods and processes for uploading one or more content items to a remote server 140 will now be described. In particular, FIG. 3 illustrates an example process for uploading one or more content items from a user device 110.

The method begins at step 302, where a request for uploading one or more content items is received at the external device 120. In one example, a user may be accessing the client application 122 on the external device 120 to perform one or more operations associated with the server 140. If the client application 122 and server host a digital design application, the one or more operations may include perusing a digital content library hosted by the digital design application, viewing or creating a digital design or document. In the process of performing such operations, the user may wish to modify an existing design or create a new design that includes one or more of the user's own images, videos or design elements that are stored on the user device 110.

In such an event, the user may decide to upload one or more content items to the computer application such that the one or more content items can be incorporated in the design the user is currently creating. The client application 122 may provide a selectable affordance (for example, an “ADD,” or “UPLOAD” button) on a displayed user interface. Selection of such an affordance or other means may generate the request for uploading the one or more content items.

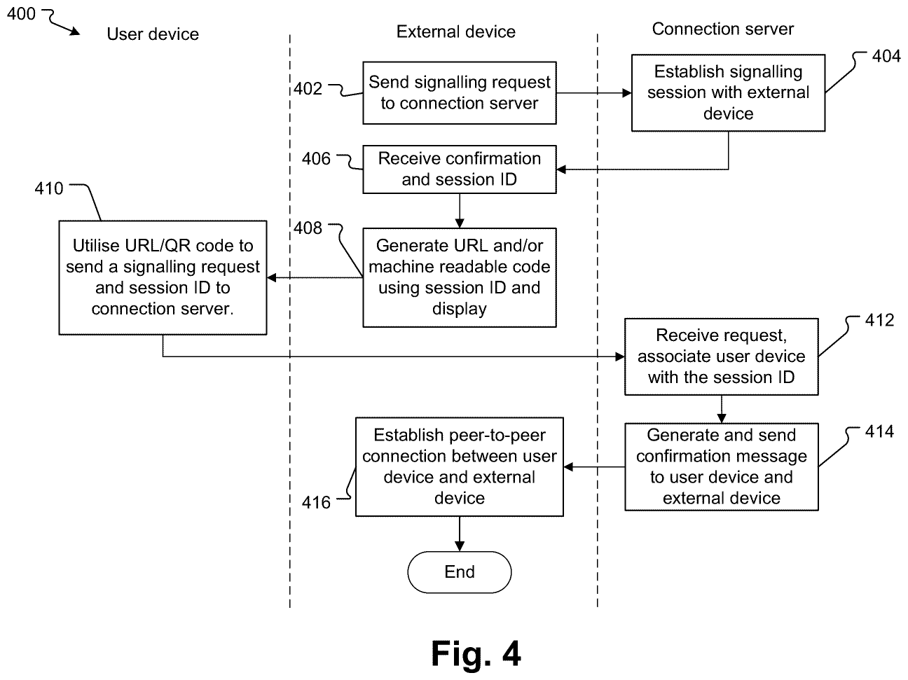

Once the request is received at the client application 122 on the external device 120, the method proceeds to step 304, where the client application 122 initiates a peer-to-peer connection with the user device 110. The manner in which this connection is initiated and established is discussed in detail with reference to FIG. 4. In one example, the connection is established via a webRTC (web real time communication) protocol.

Once the peer-to-peer connection between the client application 122 and the user device 110 is established, the method proceeds to step 306, where the external device 120 receives one or more content items from the user device 110.

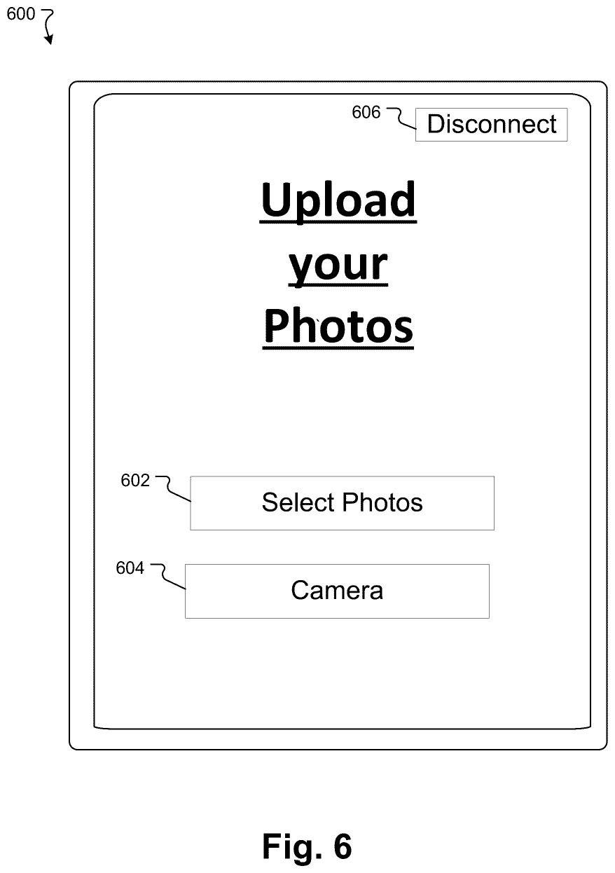

FIG. 6 shows an example UI 600 on the user device 110 after the peer-to-peer connection is established between the user device 110 and the client application 122.

The UI 600 includes an interactive control, e.g., a button 602, for accessing the media storage 112 on the user device 110. If the user selects button 602, a media storage UI may be invoked that displays the content items available in the media storage 112. The media storage UI may further include an interactive control for uploading selected content items. The user may select one or more of the content items from the media storage for uploading to the computer application. Once the content items are selected, the user may select the interactive control that causes the user device 110 to initiate transfer of the selected items to the client application 122 using the established peer-to-peer connection.

User interface 600 may also include another interactive control, e.g., a button 604, for accessing a camera of the user device (if available). If the user selects the button 604, a camera application of the user device 110 may be invoked showing an image visible in a viewfinder of the camera. Upon using the camera application to take a picture or video, the picture or video may be transmitted to the client application 122 on the external device 120 using the established peer-to-peer connection. It should be noted that UI 600 is not limited to the features displayed in FIG. 6 and may include other functionality not displayed in this UI.

In some embodiments, the media selection (e.g., via the media storage 112 or the camera) may be limited to accept content items that have a smaller size than a predetermined value (e.g., 200 mb). It may also be configured to accept a threshold number of content items. To this end, the media store UI may only display content items that have a size that is smaller than the predetermined value to prevent the user for selecting larger content items. Similarly, the media store UI may prevent selection of content items after the threshold number of content items have been selected. In another example, the media store UI may display all available content items and not place any restrictions on the number of content items that the user can select. However, once the user selects the interactive control to upload the selected content items, an error message may be displayed if the size of any of the content items exceeds the predetermined value and/or if the number of selected content items exceeds the threshold number. The error message may indicate the type of error. In response, the user can remove any larger content items and/or reduce the number of selected content items to the threshold value before selecting the interactive control to transfer the content items.

The process of transferring the content items from the user device to the client application 122 via the peer-to-peer connection may include, but is not limited to, splitting the content items into smaller fragments with a suitable header. Upon receiving the fragments and headers of the content items, the client application 122 may reconstruct the content items. After the content items have been reconstructed, the method 300 proceeds to step 308 where client application 122 automatically uploads the reconstructed content items to the server 140 using the communication network 150 (e.g., using a public network such as the Internet). Once the content items are uploaded to the server 140, they become available to use in the client application 122.

The user interface 600 also includes an interactive control, e.g., button 606, to disconnect the peer-to-peer connection between the user device 110 and the external device 120. In other cases, the disconnect button 606 may be displayed on a client application UI on the external device 120.

Upon selecting the disconnect button 606 (either from the client application 122 or the user device 110), the peer-to-peer connection between user device 110 and the external device 120 is terminated. In which case, the method 300 ends whenever the disconnect button is selected.

In some embodiments, the peer-to-peer connection may be terminated any time after step 304, e.g., by closing the client application 122 on the external device 120. In other embodiments, the peer-to-peer connection may be automatically disconnected once the content items are fully received at the client application 122 and/or once a threshold amount of time has elapsed.

FIG. 4 is a flowchart illustrating an example method for establishing the peer-to-peer connection between the user device 110 and the external device 120 (step 304). The method 400 commences once the client application 122 executing on the external device 120 receives a request to upload content items from a user device 110 (i.e., once step 302 has been performed).

At step 402, the client application 122 communicates a signalling connection request to the connection server 130 (e.g., the connection request may indicate a request to establish a websocket connection or a long-polling connection with the connection server 130).

At step 404, the connection server 130 receives the connection request and establishes the requested signalling connection (e.g., websocket or long polling connection) between the connection server 130 and the external device 120. The connection server 130 may assign a unique session identifier (ID) for the established signalling connection and may save this session ID in a local memory. The connection server 130 also communicates the session ID back to the external device 120 along with a confirmation message once the session is established.

At step 406, the client application 122 receives the confirmation message along with the session ID. The client application 122 then generates a URL or machine readable code based on the session ID.

In one embodiment, the client application generates a URL that includes an API endpoint of the connection server 130 and the session ID received from the connection server. In another embodiment, the client application 122 formats the API endpoint and session ID in a serial format (similar to a URL) and then converts this into a machine readable code (e.g., a QR code). The dimensions of the code may depend on the amount of data encrypted in the code and the error correction required.

Once the URL and/or machine readable code is generated, the client application 122 displays the URL or machine readable code in a UI on the external device 120.

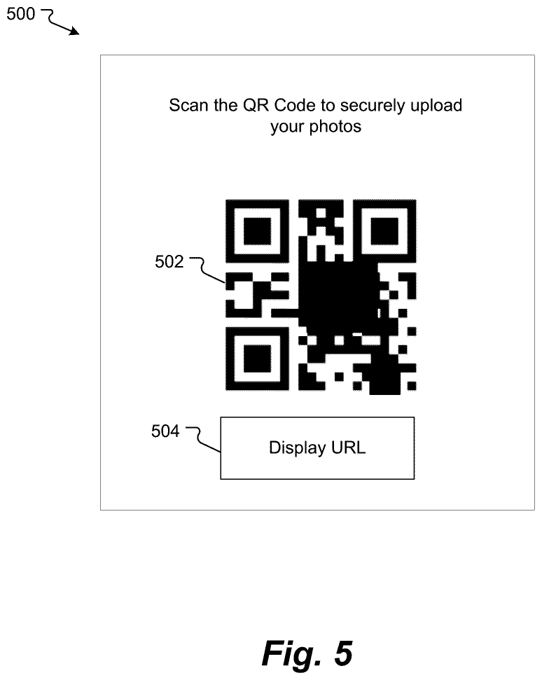

FIG. 5 illustrates an example UI 500 displaying the generated URL and/or machine-readable code. In this example, the UI displays just the machine-readable code. However, in other embodiments, the UI 500 may display both or just the URL. This UI 500 is displayed in response to the user selecting the UPLOAD or ADD interactive control at step 302. In addition to displaying the machine-readable code 502, the UI also includes some instructions to guide the user to scan the machine-readable code 502 with the user device 110.

In some examples, where the UI does not display the URL, the UI 500 may include an interactive control to display the URL. This may be useful in case the user has a user device that does not include a camera or machine readable code reader 114. The user may select the interactive control to swap the QR code for the URL or to additionally display the URL.

At step 410, the user device 110 utilises the URL or machine-readable code displayed by the external device 120 to initiate communication with the connection server 130. For example, in case the external device displays a URL, the user may type the URL in a search bar of a web browser executing on the user device 110. Alternatively, if the external device 120 displays a QR code, the machine readable code reader 114 of the user device 110 scans and decrypts the QR code. Either case (entering of the URL or scanning of the QR code) results in the user device 110 automatically opening the URL and being directed to an upload page made available by the connection server 130. Depending on the implementation, the upload page may be provided by the client application 122, the connection server 130, or another remote application on the server 140.

The upload page includes software code that utilises the session ID to establish the connection to the signal server endpoint, and then also to establish a peer to peer connection with the client application 122. The uploading page also receives the session ID that was embedded in the QR code or available as part of the URL and communicates this session ID to the connection server 130 along with a request for a signalling connection.

The connection server 130 receives the session ID provided by the user device at step 412 and performs a lookup with this session identifier in database 132. If the connection server 130 identifies a match for the session ID in the database 132, it determines that a session is already established with the external device 120 and establishes the same session with the user device 110. This includes using the same session identifier for the connection with the user device 110. Further, at step 414, the connection server 130 may communicate a confirmation message to the user device 110 and the external device-informing both that a signalling connection is established between the user device and the external device. Thereafter, any messages communicated from the external device to the connection server 130 are automatically forwarded to the user device 110 and vice versa.

Once the signalling connection is established between the external device 120 and the user device 110 via the connection server 130. A peer-to-peer connection can be established between these two devices using the signalling connection.

At step 416, the external device 120 initiates the peer-to-peer connection in response to receiving the confirmation message from the connection server 130 indicating that the user device 110 is also connected to the session. The process for establishing the peer-to-peer connection will vary depending on the underlying technology utilized. It generally includes an exchange of handshake messages between the two devices. In case the peer-to-peer network is a webRTC connection, establishing the connection includes an offer and response stage, a candidate establishment stage and a connection stage.

During the offer and response stage, the external device 120 generates an offer using an API of the WebRTC protocol. The offer generally includes information about the capabilities and preferences of the external device, which may include information such as supported audio and video codecs, bandwidth constraints, and any other specific requirements for the communication session.

The offer is communicated from the external device 120 to the user device via the signalling connection.

Upon receiving the offer, the user device 110 processes the offer and generates a response. The response generally includes information about the user device's 110 capabilities and preferences. The user device 110 then communicates these back to the external device 120 via the signalling connection.

During the connectivity establishment stage, the devices discover and establish the best communication path between each other by determining the network addresses and transport protocols that can be used for the peer-to-peer connection.

In this stage, both the devices can gather information about possible candidate addresses and protocols that can be used for communication. These candidates are determined by querying the operating system for local IP addresses, ports, and transport protocols (e.g., available WiFi or mobile networks that the user device and/or external device are connected to).

Once the two devices identify potential candidates, they exchange this information through the signalling connection. The exchange of candidates allows each device to learn about the network addresses and transport options available on the other device.

Any commonly available candidates can then be used to establish the connection.

In some examples, the peer-to-peer connection between the external device 120 and the user device 110 may an RTCDataChannel. This ensures that any data transmitted through the connection is automatically secured using Datagram Transport Layer Security (DTLS) such that the data is encrypted and the data flow is safe.

In some embodiments after step 416, the signalling connection between the connection server 130 and the external device 120 as well as the signalling connection between the connection server 130 and the user device 110 may be terminated. This is done as the signalling connection is not required after the peer-to-peer connection has been established. In some examples, the external device may communicate a session disconnection request to the connection server 130. The connection server 130 receives the request and disconnects the session (e.g., by clearing the session identifier from the local database).

In other embodiments, the connection server 130 may automatically disconnect the signalling connection between the user device 110 and the external device 120. This prevents the signalling connection from remaining active for a long period and unnecessarily consuming network resources (in case the user does not scan the QR code or type the URL in a web browser or initiate the peer-to-peer connection). To this end, the connection server 130 may set an automatic timer (e.g., 5 minutes) once the session identifier is generated. When the time ends, the connection server 130 automatically ends the signalling connection.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first candidate design template could be termed a second candidate design template or vice versa without departing from the scope of the described examples. Furthermore, when used to differentiate elements or features, a second candidate design template could exist without a first candidate design template. For example, a second user input could occur before a first user input (or without a first user input ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer-implemented method including:
receiving, at a client application executing on a first device, a request to upload a content item to a server system;
establishing a peer-to-peer connection between the client application on the first device and a second device;
transferring from the second device to the client application on the first device, the content item, the content item transferred via the peer-to-peer connection; and
uploading the content item from the client application to the server system using a different communication channel between the first device and the server system.

2. The computer-implemented method of claim 1, wherein establishing the peer-to-peer connection includes:
establishing a signalling connection between a connection server and the client application on the first device;
establishing the signalling connection between the connection server and the second device;
upon determining that the signalling connection between the connection server and the client application and the second device was successful, establishing the peer-to-peer connection between the client application and the second device using the signalling connection; and
upon determining that the peer-to-peer connection between the client application and the second device was successful, terminating the signalling connection between the connection server and the client application and the second device.

3. The computer-implemented method of claim 2, wherein establishing the signalling connection between the client application on the first device and the second device comprising:
generating and communicating a request for the signalling connection from the first device to the connection server.

4. The computer-implemented method of claim 3, further comprising:
receiving a session identifier from the connection server in response to the connection server establishing the signalling connection between the connection server and the client application on the first device.

5. The computer-implemented method of claim 4, further comprising:
generating a machine readable code, the machine readable code comprising the session identifier; and
displaying, by the first device, the machine readable code.

6. The computer-implemented method of claim 5, wherein establishing the signalling connection between the second device and the connection server comprises:
scanning and decrypting, by the second device, the machine readable code displayed by the first device to obtain the session identifier; and
automatically generating and communicating, by the second device, a signalling connection request to the connection server, the signalling connection request comprising the session identifier.

7. The computer-implemented method of claim 6, further comprising:
receiving, at the first device, a confirmation from the connection server that the second device is connected to signalling connection; and
initiating, by the first device, the peer-to-peer connection with the second device using the signalling connection.

8. The computer-implemented method of claim 1, wherein the signalling connection is ended after a threshold period of time if the peer-to-peer connection is not established within the threshold period of time.

9. The computer-implemented method of claim 1, wherein after establishing the peer-to-peer connection between the first and second device, displaying on at least the first device or the second device an interactive control to disconnect the peer-to-peer connection.

10. The computer-implemented method of claim 9, wherein in response to determining that the interactive control has been selected, disconnecting the second device from the first device.

11. A non-transitory computer-readable medium comprising instructions, which when executed by a processor cause the processor to:
receive, at a client application executing on a first device, a request to upload a content item to a server system;
establish a peer-to-peer connection between the client application on the first device and a second device;
transfer from the second device to the client application on the first device, the content item, the content item transferred via the peer-to-peer connection; and
upload the content item from the client application to the server system using a different communication channel between the first device and the server system.

12. The non-transitory computer-readable medium of claim 11, wherein establishing the peer-to-peer connection includes:
establishing a signalling connection between a connection server and the client application on the first device;
establishing the signalling connection between the connection server and the second device;
upon determining that the signalling connection between the connection server and the client application and the second device was successful, establishing the peer-to-peer connection between the client application and the second device using the signalling connection; and
upon determining that the peer-to-peer connection between the client application and the second device was successful, terminating the signalling connection between the connection server and the client application and the second device.

13. The non-transitory computer-readable medium of claim 12, wherein establishing the signalling connection between the client application on the first device and the second device comprises:
generating and communicating a request for the signalling connection from the first device to the connection server.

14. The non-transitory computer-readable medium of claim 13, further comprising instructions which when executed by the processor further cause the processor to:
receive a session identifier from the connection server in response to the connection server establishing the signalling connection between the connection server and the client application on the first device.

15. The non-transitory computer-readable medium of claim 14, further comprising instructions which when executed by the processor further cause the processor to:
generate a machine readable code, the machine readable code comprising the session identifier; and
display, by the first device, the machine readable code.

16. The non-transitory computer-readable medium of claim 15, wherein establishing the signalling connection between the second device and the connection server comprises:
scanning and decrypting, by the second device, the machine readable code displayed by the first device to obtain the session identifier; and
automatically generating and communicating, by the second device, a signalling connection request to the connection server, the signalling connection request comprising the session identifier.

17. The non-transitory computer-readable medium of claim 16, further comprising instructions which when executed by the processor further cause the processor to:
receive, at the first device, a confirmation from the connection server that the second device is connected to the signalling connection; and
initiate, by the first device, the peer-to-peer connection with the second device using the signalling connection.

18. The non-transitory computer-readable medium of claim 11, wherein the signalling connection is ended after a threshold period of time if the peer-to-peer connection is not established within the threshold period of time.

19. The non-transitory computer-readable medium of claim 11, wherein after establishing the peer-to-peer connection between the first and second device, displaying on at least the first device or the second device an interactive control to disconnect the peer-to-peer connection.

20. The non-transitory computer-readable medium of claim 19, wherein in response to determining that the interactive control has been selected, disconnecting the second device from the first device.
